(19) United States
(12) Patent Application Publication
(10) Pub. No.: US 2013/0275058 A1
(43) Pub. Date: Oct. 17, 2013

(54) APPARATUS AND METHOD FOR A PRESSURE SENSITIVE DEVICE INTERFACE

(71) Applicant: Ihab A.B. Awad, Palo Alto, CA (US)

(72) Inventor: Ihab A.B. Awad, Palo Alto, CA (US)

(73) Assignee: GOOGLE INC., Mountain View, CA (US)

(21) Appl. No.: 13/446,933

(22) Filed: Apr. 13, 2012

(51) Int. Cl. G06F 19/00; G01L 1/22

(52) U.S. Cl. 702/42; 73/862.627

(57) ABSTRACT

A pressure sensitive device interface including a display screen, a framing structure that receives a force applied to the portable electronic device and exhibits strain within the framing structure, a strain gauge that identifies the strain within the framing structure, and a processor coupled to the display screen and the strain gauge and configured to measure the strain identified by the strain gauge and control the user interface according to the measurement of the strain. Among aspects, the framing structure may include a first pair of parallel elements that form opposing elongated outer edges of the portable electronic device, and a second pair of parallel elements that extend perpendicularly between the first pair of parallel elements. Among additional aspects, the processor may be further configured to identify a plurality of gestures with reference to strain metrics.

### BACKGROUND

Handheld portable electronic devices such as mobile phones are now capable of functions similar to personal computers. Compared to personal computers which offer several input devices such as keyboards, mice, and other input devices, handheld portable electronic devices are relatively small in size and offer more limited options for input. Handheld portable electronic devices are designed to be small in size, lightweight, and preferably operable using one hand. As the design of handheld portable electronic devices is driven by these considerations and one-handed ergonomics, engineers have undertaken the task of designing new input devices suited for handheld portable electronic devices.

Many handheld portable electronic devices now include multi-touch capacitive interfaces integrated with a display, so the devices may obtain inputs from a user based on the user's touch or multi-touch of the capacitive interface in association with a particular image displayed on the display.

Other examples of input devices include buttons and track balls, which are sometimes included on one side of a portable electronic device. Buttons and track balls of various types are known and may be manipulated by a user's thumb, but typically offer little flexibility.

### SUMMARY

Embodiments of a pressure sensitive device are described. In one embodiment, a pressure sensitive device interface of a portable electronic device is described including a display screen that displays a user interface, a framing structure that receives a force applied to an external surface of the portable electronic device and exhibits strain, a strain gauge that identifies the strain within the framing structure, and a processor coupled to the display screen and the strain gauge and configured to measure the strain identified by the strain gauge to produce a measurement of the strain, and control the user interface according to the measurement of the strain. Among aspects, the framing structure may include a first pair of parallel elements that form opposing elongated outer edges of the portable electronic device, and a second pair of parallel elements that extend perpendicularly between the first pair of parallel elements at respective ends of the first pair of parallel elements.

In some embodiments, the portable electronic device may further include interface circuitry that quantifies strain within the framing structure, and the strain gauge may comprise a plurality of strain gauges, where at least one of the plurality of strain gauges is positioned on a framing structure in an orientation that is different than another one of the plurality of strain gauges. In other aspects, each of the plurality of strain gauges may be positioned at respective orientations on a framing structure.

In certain aspects, the measurement of strain may include a magnitude of strain for each of a plurality of strain gauges, and a processor may be configured to measure a magnitude of strain for each of the plurality of strain gauges, and, for each magnitude of strain, assign a direction to the magnitude of strain to produce an individual strain metric for each of the plurality of strain gauges. The processor may be further configured to sum the individual strain metrics according to vector mathematics to produce an overall strain metric comprising magnitude and direction attributes, and identify a gesture with reference to the individual and overall strain metrics.

Among other aspects, identified gestures may include a squeeze, a shear, or a splay gesture. A processor may be further configured to control an application executing on the portable electronic device to execute a particular instruction based on an identified gesture. For example, the processor may be configured to control an application executing on the portable electronic device to select an item displayed on the display screen according to a squeeze gesture, control an application executing on the portable electronic device to rotate an item displayed on the display screen according to a shear gesture, and control an application executing on the portable electronic device to return to a previously displayed list according to a splay gesture.

Embodiments further include a portable electronic device including a framing structure that receives a force applied to the framing structure and exhibits strain, a strain gauge that identifies the strain within the framing structure, and a processor configured to measure the strain identified by the strain gauge to produce a measurement of the strain, and identify a gesture according to a value of the measurement of the strain.

Embodiments of a method of controlling a portable electronic device are also described. In one embodiment, the method includes displaying a user interface of the portable electronic device, receiving a force applied to an external surface of the portable electronic device and exhibiting strain within a framing structure of the portable electronic device, identifying, by a strain gauge, the strain within the framing structure, and measuring the strain identified by the strain gauge.

### BRIEF DESCRIPTION OF THE DRAWINGS

For a more complete understanding of the invention and the advantages thereof, reference is now made to the following description in conjunction with the accompanying figures briefly described as follows:

FIG. 1 illustrates an example embodiment of a functional block diagram of a portable electronic device;

FIG. 2 illustrates an example embodiment of a portable electronic device;

FIG. 3 illustrates an example embodiment of a framing structure;

FIG. 4 illustrates an example strain gauge;

FIG. 5 illustrates an example framing element and strain gauges;

FIG. 6 illustrates an example embodiment of an integrated framing structure;

FIG. 7 illustrates examples of gestures for controlling an application;

FIG. 8 illustrates examples of directions taken by applications according to various gestures; and

FIG. 9 illustrates an example flow diagram of a method of controlling a portable electronic device.

### DETAILED DESCRIPTION

Embodiments described herein provide an apparatus and method for a pressure sensitive device interface. For example, according to the apparatus and method described herein, a user may control functions of a portable electronic device such as a portable telephone, portable music player, portable organizational device, or other portable computing device by applying physical forces to exterior surfaces of the device. Although substantially described in conjunction with portable electronic devices, the principles described herein may be applied to other devices regardless of size or shape.

According to the apparatus and method described herein, physical forces imparted upon a framing structure of a portable electronic device result in strain within the structure, which is measured using one or more sensors such as strain gauges secured to, formed on, integrated with, or embedded within the framing structure. In embodiments, the one or more strain gauges may be located remotely from a point of contact where physical forces are applied to the framing structure.

Among aspects, the strain gauges are used by a portable electronic device as part of a pressure sensitive device interface. The pressure sensitive device interface is adapted to identify and distinguish between different magnitudes of physical force or strain applied to external surfaces of the portable electronic device. For example, the pressure sensitive device interface may measure and interpret a compressive force applied to two opposing sides of the portable electronic device and execute a command such as zooming in on a displayed image. The use of strain gauges secured to, formed on, integrated with, or embedded within a framing structure of the portable electronic device facilitates one-handed ergonomic use of the portable electronic device while offering a flexible and intuitive input interface.

Based upon the placement and orientation of the one or more strain gauges, the pressure sensitive device interface may recognize and interpret force imparted upon a framing structure in more than one dimension and over a range of magnitudes. For example, the pressure sensitive device interface described herein is configured to interpret strain in more than one direction. The directions in which strain is measured may be orthogonal or nearly orthogonal. By combining various directions and magnitudes of strain, a continuous or near-continuous multi-directional metric may be calculated for use as an input.

In this manner, the pressure sensitive device interface is able to interpret multi-dimensional compressive forces, tensile forces, shear forces, rotational forces, and other forces or strains. Each of these forces or strains may correspond to different respective input commands for applications executing on the electronic portable device. The input commands may control different responses or functions based on application type. For example, a strain measurement may control a different response from an e-mail application than from a web-browser application. Also, the input commands may be further customized via software to offer further input options. In this way, a user of the device may be able to input a wide number and range of possible commands via the pressure sensitive device interface.

Turning to the figures, in which like numerals indicate like elements throughout, various embodiments are described in detail.

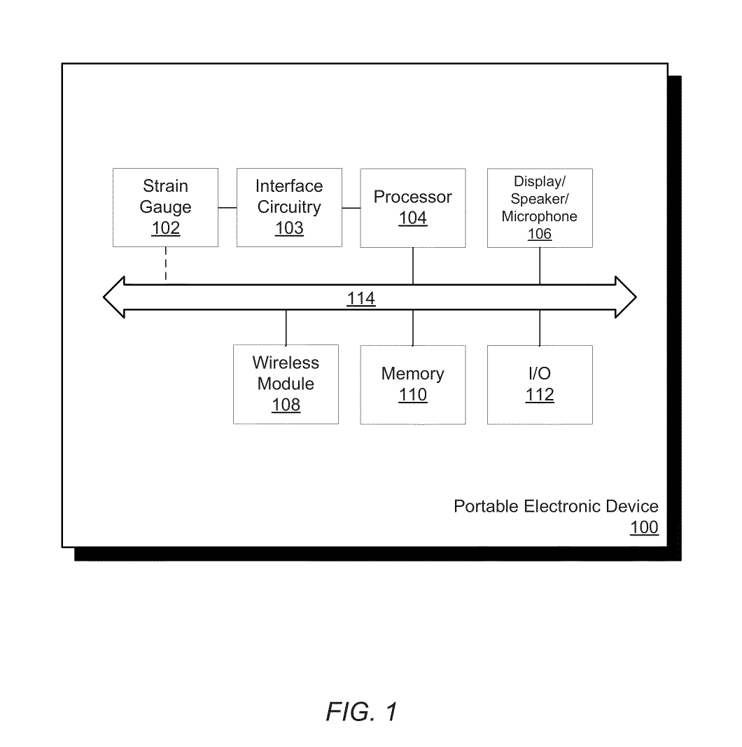

FIG. 1 illustrates an example block diagram of a portable electronic device 100. As illustrated in FIG. 1, the portable electronic device includes strain gauge 102, interface circuitry 103, processor 104, display/speaker/microphone 106, wireless module 108, memory 110, and I/O 112. In FIG. 1, elements of the portable electronic device 100 are electrically and communicatively interconnected via a bus 114. According to the embodiment of FIG. 1, the strain gauge 102 is coupled to the processor 104 via the interface circuitry 103. Additionally or alternatively, the strain gauge 102 may be connected to the processor 104 via the bus 114, as suggested by the dashed line in FIG. 1.

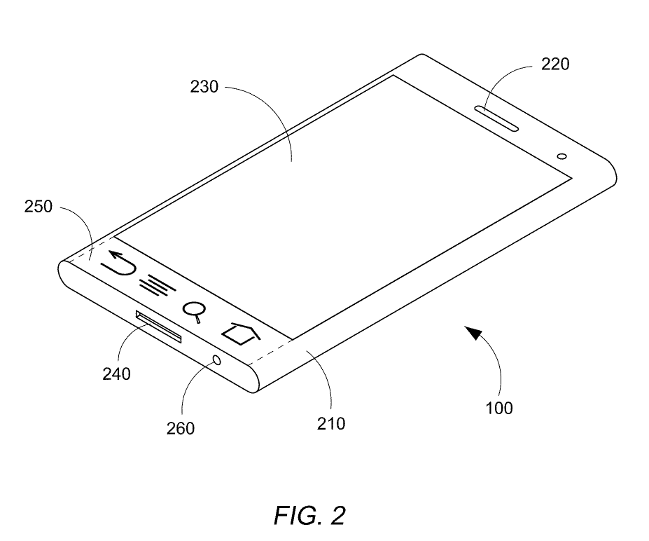

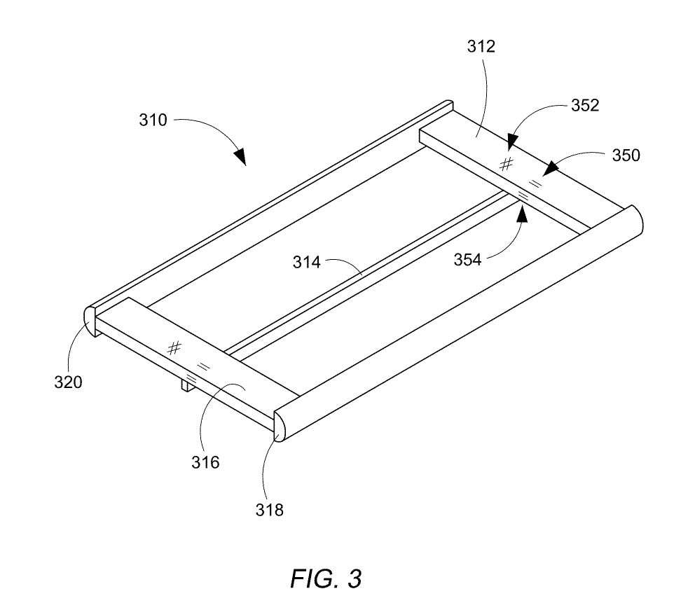

Among embodiments, the strain gauge 102 comprises one or more strain gauges configured to identify strain imparted by forces applied upon external surfaces of the portable electronic device 100 and provide an output signal based on the strain. The exterior aspects and design of the portable electronic device 100 are described in further detail below with reference to FIG. 2. Each of the strain gauges may reside at a different respective position and/or orientation with respect to a framing structure of the portable electronic device 100, as described in additional detail below with regard to FIG. 3, such that strain in more than one dimension may be identified. Each of the strain gauges may also be used to measure a magnitude of strain across a range of values.

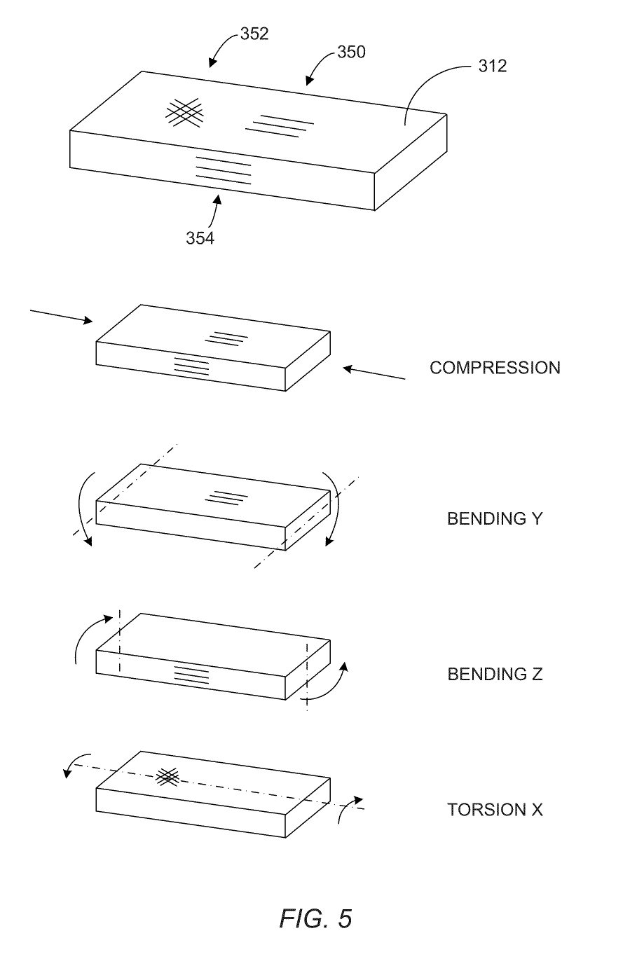

The interface circuitry 103 comprises circuitry configured to quantify strain identified by the strain gauge 102. As one example, a bridge of the interface circuitry 103 may become unbalanced when strain is imparted upon the strain gauge 102. A change in DC voltage required to rebalance the bridge may correspond to an associated amount of strain imparted upon the strain gauge 102, which may be measured by the processor 104. The interface circuitry 103 is described in further detail below with reference to FIG. 5.

The processor 104 may comprise one or more specific or general purpose processors configured to execute instructions stored on the memory 110 that, when executed, control the processor 104 to execute various applications and perform various functions associated with the portable electronic device 100. Additionally or alternatively, the processor 104 may include a programmable gate array and operate, at least in part, based on firmware. As an example, the processor 104 may execute instructions stored on the memory 110 including instructions for an operating system of the portable electronic device 100 and instructions for applications. The applications that may be executed by the portable electronic device 100 include an e-mail application, a photo viewer application, a map viewer application, a web-browser application, a mobile phone application, and a music player application, among others. The processor 104 is further configured to measure a magnitude of strain identified by each of a plurality of strain gauges, as described in additional detail below. In this context, the memory 110 may store instructions that, when executed by the processor 104, direct the processor to measure strains identified by the strain gauge 102 and identify input commands based on the measured strains. The input commands control applications executing on the portable electronic device 100 to perform various tasks or functions associated with the applications.

The display/speaker/microphone 106 is configured to display applications executing on the processor 104 and provide visual and audible feedback to a user of the portable electronic device 100. To that end, the display/speaker/microphone 106 may comprise one or more display devices such as LCD, LED, OLED, and Electronic Ink displays, among others. The display/speaker/microphone 106 may also comprise one or more speakers and one or more microphones. Among embodiments, the display of the portable electronic device occupies at least a portion of a surface of the portable electronic device 100. The portable electronic device 100 may also include a camera, a flash, a haptic feedback motor, a GPS receiver, and an integrated keyboard, among other elements.

The wireless communication module 108 is configured to provide wireless communication of data to and from the portable electronic device 100. As a non-limiting group of examples, the wireless communication module 108 may be configured for cellular communications using one or more of GSM, CDMA, TDMA, OFDM and other cellular communications protocols, wireless area network communications using more or more of the family of 802.11x protocols and other wireless area network communications protocols, and Bluetooth communications protocols.

The memory 110 may comprise a Random Access Memory (RAM), Read Only Memory (ROM), or any other tangible storage memory configured to store software programs for execution by the processor 104. As a non-limiting example group, the memory 110 may comprise one or more of dynamic, persistent, and semi-persistent solid state memories, magnetic memories, removable memories, or any other known memories suitable for the application of storing data and software programs for the portable electronic device 100.

The I/O 112 includes inputs and outputs of the portable electronic device 100 such as power connectors, data connectors, and other input and output devices. The I/O 112 may comprise, for example, wired data communication input and output interfaces, power charging interfaces, infra-red interfaces, light and proximity sensors, capacitive sensors, “soft” and “hard” buttons, switches, and other input/output interfaces of the portable electronic device 100. The bus 114 is configured to electrically and communicatively connect the processor 104, the display/speaker/microphone 106, the wireless module 104, the memory 110, and the I/O 112 for transfer of data and instructions between elements of the portable electronic device 100.

FIG. 2 illustrates an example embodiment of the portable electronic device 100. As illustrated in FIG. 2, the portable electronic device 100 includes a framing structure 210, a speaker 220, a display 230, a data input/output port 240, a plurality of input buttons 250, and a microphone 260. A user of the portable electronic device 100 is able to hold the device in one hand, view images on the display 230, and provide inputs to the portable electronic device 100 by touching the display 230 and pressing the buttons 250. The portable electronic device 100, as directed by software programs executed by the processor 104, may display a graphical user interface associated with various applications on the display 230. The portable electronic device 100 also includes a pressure sensitive device interface as described herein, which is sensitive to forces applied to the framing structure 210. It is noted that the structure, shape, and size of the portable electronic device 100 illustrated in FIG. 3 is provided only as an example, and other structures, shapes, and sizes are within the scope of the embodiments described herein. The portable electronic device 100 may include one or more buttons in addition to the buttons 250 or omit the buttons 250. Likewise, the portable electronic device 100 may include one or more speakers in addition to the speaker 200 or omit the speaker 220, and may include ports in addition to the port 240 or omit the port 240.

As discussed above, the portable electronic device 100 is generally designed to be operated by a single hand. However, inputting commands by touching the display 230 requires either a thumb of one hand supporting the portable electronic device 100 or an index finger of a hand other than the hand holding the portable electronic device 100. Likewise, inputting commands by touching the buttons 250 requires a thumb of a hand supporting the portable electronic device 100 or an index finger of a hand other than the hand holding the portable electronic device 100. In many situations, this arrangement is cumbersome for a user. For example, a user may have only one hand free because the user's other hand may be occupied with another activity. Furthermore, to accurately input a command based upon a graphical user interface displayed on the display 230, a user must visually reference the display 230 before touching the display—requiring the user's attention to shift from other activities. A user may become frustrated with visually referencing the display 230 every time a routine input command must be provided. For example, in the context of playing music on the portable electronic device 100, a user may routinely wish to advance to a next song in a playlist during a physical activity without visually referencing the device. It is also noted that the display 230 and the buttons 250 may not include any tactile references. Thus, a user may be unable to distinguish between any two points over the display 230 or any two of the buttons 250 using tactile references (e.g., raised dots), necessitating the user to visually reference the portable electronic device 100 before providing an input with precision.

In connection with the apparatus and method described herein, the above-discussed limitations may be addressed using strain gauge sensors that identify forces imparted to a framing structure of the portable electronic device 100. In other words, embodiments described herein implement a pressure sensitive device interface using feedback from strain gauges that identify partial physical deformation of the framing structure. The strain gauges may be secured to, formed on, integrated with, or embedded within elements of the framing structure. Among embodiments, the pressure sensitive device interface may recognize and interpret different types of strain. For example, the pressure-sensitive device may recognize compressive forces, tensile forces, shear forces, rotational forces, and other types of forces. Further, the pressure-sensitive device interface recognizes and interprets various magnitudes or proportions of various types of strain. In this context, proportions of strain may correspond to a plurality of different commands.

FIG. 3 illustrates an example embodiment of a framing structure 310 similar to the framing structure 210 that receives a force applied to an external surface of the portable electronic device 100 and exhibits strain within the framing structure 310. As illustrated at FIG. 3, the framing structure 310 comprises framing elements 312, 314, 316, 318, and 320. Elements 318 and 320 run parallel to each other and form opposing elongated outer edges of the portable electronic device 100 typically grasped by a hand of a user. Elements 312 and 316 run parallel to each other and perpendicularly between the elements 318 and 320 at respective ends of the elements 312 and 316, as illustrated. The framing structure illustrated in FIG. 3 is provided only as an example, and additional or fewer framing elements may be provided and positioned at various other locations. In aspects, strain gauges are integrated on or in one or more of the framing elements 312, 314, and 316. The framing structure 210 illustrated in FIG. 3 includes a backbone beam element 314 which translates force between the framing element 312 and the framing element 316. The framing structure 310 may include backbone beam elements in addition to the backbone beam element 314 or omit the backbone beam element 314.

As illustrated in FIG. 3, each of the framing elements 312 and 316 includes strain gauges 350, 352, and 354. In the example illustrated in FIG. 3, each of the strain gauges is positioned to measure a different type of strain. The position and orientation of a strain gauge may determine a direction of strain identified by the gauge. Thus, each framing element may include multiple strain gauges formed upon or integrated within one or more sides of the element. Other than those illustrated in FIG. 3, various forms, positions, and orientations of strain gauges are within the scope of the embodiments described herein. Also, among embodiments, the strain gauges may be selected from a group comprising uniaxial, biaxial, and triaxial gauges depending upon the type of strains to be identified.

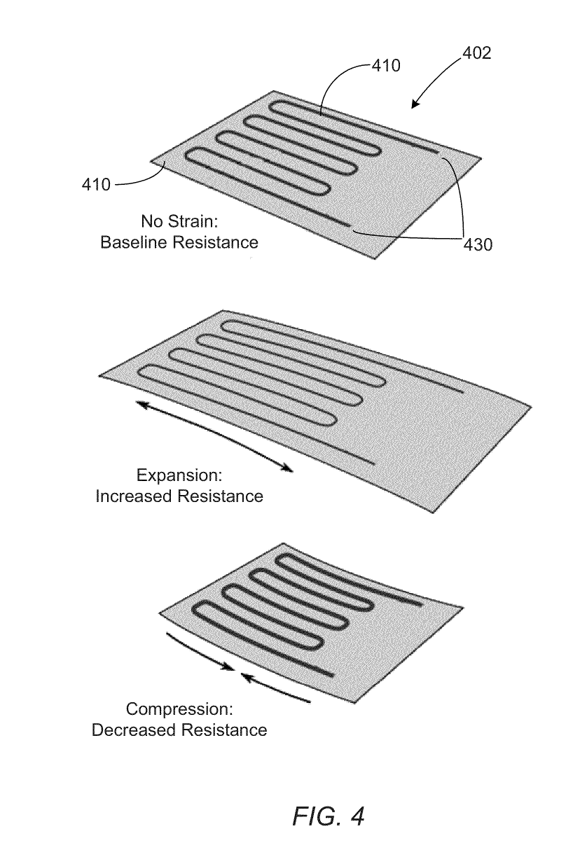

Turning to FIG. 4, an example strain gauge 402 is illustrated. Although described below in terms of a metallic foil strain gauge, the strain gauge 402 may be any type of strain gauge. It is noted that any suitable type of strain gauge may be used among embodiments, including optical, semiconductor, and foil gauges. In embodiments using optical strain gauges, the optical strain gauges may measure strain using reflections of light. For example, light reflections within an optical strain gauge may result in constructive and destructive interference, which may be measured by associated circuitry as strain. In some aspects, optical sensors may be selected for accuracy, lifetime stability, ease of installation, performance under a wide range of environmental conditions, and immunity to electromagnetic interference (EMI).

The strain gauge 402 illustrated in FIG. 4 may identify strain on a framing element of the framing structure 310. As an example of a strain gauge, the strain gauge 402 comprises an insulating flexible material 410 upon which a thin metallic foil pattern 420 is patterned or printed. The strain gauge 402 may be attached to a framing element by weld, adhesive, or by any other suitable manner. The strain gauge 402 may also be integrally formed or printed upon a framing element.

As illustrated in FIG. 4, the metallic foil pattern 420 comprises a long, thin, conductive strip of metallic material formed in a zig-zag pattern of parallel lines. In this formation, a small amount of strain can result in a change in an overall length of the strip and a corresponding change in resistance or conductance. It is noted that the change in resistance is proportional to the amount of strain. As the change in resistance is proportional to the amount of strain, the strain gauge 402 may be utilized to measure a range of forces imparted upon the portable electronic device 100.

The strain gauge 402 determines strain upon a framing element according to the electrical resistance or conductance particular to a geometry of the metallic foil pattern 410. When the metallic foil pattern is expanded or compressed within limits of its elasticity, the pattern will either become narrower or wider and thus increase or decrease its electrical resistance, as illustrated in FIG. 4. As a framing element is partially deformed based on forces which expand, compress, and bend the framing element at various angles, a metallic foil pattern properly mounted on the framing element will also be partially deformed, causing an electrical resistance of the metallic foil pattern to change. In this manner, expansion of the metallic foil pattern 410 may cause the resistance of the pattern to increase and contraction of the pattern may cause the resistance to decrease. In one embodiment, the interface circuitry 103 is coupled to the metallic foil pattern 410 via an electrical connection at terminals 430. The interface circuitry 103 is configured to quantify the change in resistance based on the strain imparted upon the framing element. Along with the interface circuitry 103, the processor 104 is configured to measure the change in resistance. The interface circuitry 103 and the processor 104 may be separate circuitry components, or the interface circuitry 103 and the processor 104 may integrated together.

The metallic foil pattern 410 is generally formed of very thin wire such as wire about 1/1000 of an inch in diameter or similarly thin metallic film deposited on an insulating flexible backing material. The metallic foil pattern 410 may have a resistance between approximately 30-3000 Ohms when not under strain, as a non-limiting example. Generally, the resistance of the metallic foil pattern 410 is designed such that its resistance changes only a fraction of a percent over a range strains to be measured, according to elastic limits of the pattern. A strain so great as to induce a greater change in resistance may damage a strain gauge.

One example of the interface circuitry 103 is a Wheatstone bridge. In an embodiment incorporating a Wheatstone bridge, the Wheatstone bridge may be balanced by a stabilizing DC voltage, and the metallic foil pattern 410 may comprise one leg of the bridge. Alternatively, a plurality of metallic foil patterns of respective strain gauges may comprise a plurality of legs of the bridge. When a change in resistance of the metallic foil pattern 410 occurs, the bridge of the interface circuitry 103 may become unbalanced. In one embodiment, to rebalance the bridge of the interface circuitry 103, the processor 104 adjusts an output voltage of a stabilizing DC voltage of the interface circuitry 103. The change in DC voltage required to rebalance the bridge corresponds to an associated change in resistance of the metallic foil pattern 410, which may be measured by the processor 104 using an analog to digital converter of the processor 104. With reference to formulas or lookup tables, the processor 104 is configured to measure the strain imparted on the metallic foil pattern 410 according to the change in DC voltage. In this manner, the strain imparted upon the framing structure of the portable electronic device 100 may be measured by the processor 104. In this context, a smaller change in DC voltage may correspond to a relatively lesser strain than a greater change in DC voltage. Although the interface circuitry 103 is described above with reference to a Wheatstone bridge, alternative structures and designs of interface circuitry are within the scope of the description provided herein and would be understood by those having skill in the art.

In embodiments including semiconductor or optical strain gauges, the interface circuitry 103 may be selected accordingly as understood by one having ordinary skill in the art. In other words, for embodiments including semiconductor or optical strain gauges, the interface circuitry 103 may measure strain in a manner similar as to that described above, but using appropriate circuitry and/or optics suitable for taking measurements from the semiconductor or optical strain gauges. For example, when using optical strain gauges, the circuitry 103 may measure constructive and destructive interference of light within the optical strain gauges.

A magnitude of strain may be respectively identified for each of a plurality of strain gauges, to produce respective strain metrics. To measure strain in more than one dimension, several different strain gauges, each being associated with a respective dimension, may be respectively balanced to quantify and measure the strain identified by each. In this case, the interface circuitry 103 quantifies strain in each respective strain gauge, and the processor 104 is configured to measure the strain in each respective strain gauge as an individual strain metric. The processor 104 is further configured to assign a direction or dimension to each individual strain metric according to a respective position, orientation, or type of strain gauge from which the individual strain metric was measured. The assignment of dimensions to individual strain metrics is described in further detail below with reference to FIG. 5.

The processor 104 is further configured to sum the individual metrics, which each include a direction and a magnitude, according to rules of vector mathematics, to produce an overall metric of strain including both magnitude and direction. According to embodiments, one or more of the individual metrics and the overall metric may be utilized individually or in combination as an input or inputs of applications executing on the portable electronic device 100.

FIG. 5 illustrates example illustrations of various strains applied to the framing element 312. In FIG. 5, the strain gauges 350 and 352 reside on a different side of the framing element 312 than the strain gauge 354, and the strain gauge 352 is positioned at an orientation different than the orientation of the strain gauge 350. Using the strain gauges 350, 352, and 354, various strains applied to the framing element 312 may be identified, quantified, and measured. For example, compression of the framing element 312 may be detected by the strain gauges 350 and 354 based upon compression of the framing element 312 at opposing sides of the framing element 312. Further, bending about a first “Y” axis of the framing element 312 may be detected by the strain gauge 350. Bending about a second “Z” axis of the framing element 312 may be detected by the strain gauge 354. Torsion about a third “X” axis of the framing element 312 may be detected by the strain gauge 352. It is also noted that, although each strain gauge may be positioned to detect a strain about a respective dimension or axis of the framing element 312, the strain gauges may be used, in concert, to detect strains in an average or aggregate dimension for added granularity. It is additionally noted that force or strain present upon the framing element 312 may be translated to the framing element 316 via the backbone beam framing element 314. Further, the backbone beam framing element 314 may also translate force applied to the back of the portable electronic device 100 according to certain gestures such as the “splay” gesture which is described in further detail below.

As described above, the processor 104 is configured to measure an individual strain metric for each of the strain gauges 350, 352, and 354. The processor 104 is further configured to assign a “direction” to each individual strain metric. For example, processor 104 is configured to assign a first direction to the strain metric measured for strain gauge 350, assign a second direction to the strain metric measured for strain gauge 352, and assign a third direction to the strain metric measured for strain gauge 354. It is noted that the processor 104 is configured to assign a direction to an individual strain metric based upon a position, an orientation, or a type of strain gauge from which the individual strain metric was measured. With reference to FIG. 5, for example, the processor 104 may be configured to assign directions to strain metrics based upon the type of each of the strain gauges 350, 352, and 354, the respective positions of each of the strain gauges 350, 352, and 354, and the respective orientations of each of the strain gauges 350, 352, and 354.

As illustrated in FIG. 5, the strain gauge 352 is positioned at a different orientation on the framing element 312 than the strain gauge 350. That is, the strain gauge 352 may be rotated by 45 degrees as compared to the strain gauge 350. Other rotations or orientations of the strain gauge 352 are within the scope of the disclosure. Thus, although both the strain gauges 350 and 352 are positioned upon a same side of the framing element 312, the processor 104 assigns a respective direction to the strain metric measured using each, because a strain gauge rotated by 45 degrees may identify strain in a direction different than a strain gauge that is not rotated. Similarly, the processor 104 assigns a different direction to the strain metric measured using the strain gauge 350 than the strain gauge 354, because the strain gauge 350 is positioned upon a different side of the framing element 312 than the strain gauge 354. After the processor 104 assigns a direction to each strain metric, each strain metric includes magnitude and direction attributes.

In aspects, the processor 104 is configured to sum individual strain metrics, each including a magnitude and a direction, according to rules of vector mathematics, to produce an overall metric of strain including a magnitude and a direction. According to embodiments, one or more of the individual metrics and the overall metric may be used individually or in combination as an input or inputs for applications executing on the portable electronic device 100.

The processor 104 is further configured to collect and store the individual and overall metrics, average the metrics, apply various statistical algorithms to the metrics, track a history of the metrics, and filter the metrics. The processor 104 may be configured to store the individual and overall metrics in the memory 110. As one example of filtering the metrics, the processor 104 is configured to rely upon a simple or exponential moving average of collected metrics, to filter outlying metrics. Further, the processor 104 may apply algorithms to address (i.e., compensate for) non-linearities of the strain gauges and/or variations in the electrical resistance of the strain gauges due to temperature or other environmental factors. In certain embodiments, the interface circuitry 103 may additionally include a temperature sensor, and the processor 104 may be further configured to correct temperature-sensitive non-linearities of strain gauges based upon a temperature measured by the temperature sensor.

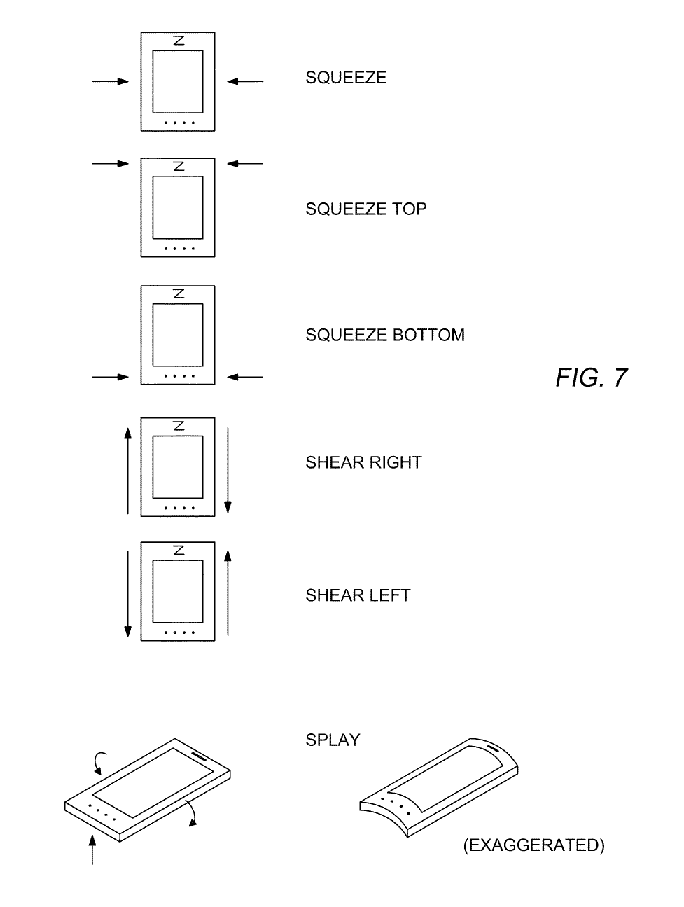

Based upon strain measurements gathered by the processor 104 using the strain gauges, the processor 104 is further configured to provide inputs to various software applications as described below with reference to FIG. 7.

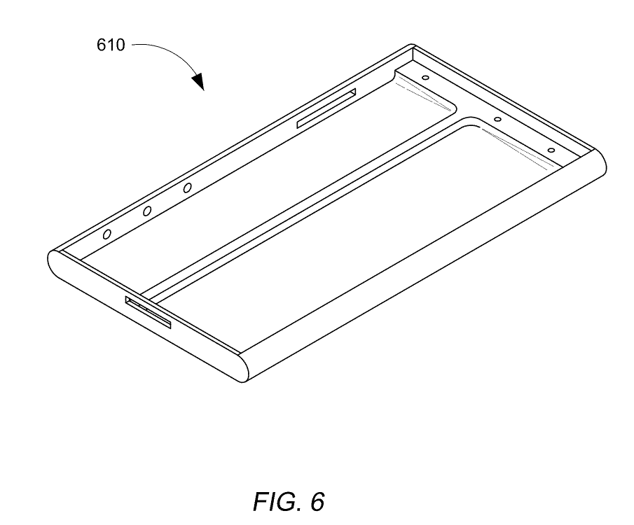

Turning to FIG. 6, an example embodiment of an integrated frame 610 including strain gauges is illustrated. The integrated frame 610 illustrated in FIG. 6 includes strain gauges positioned at various locations to detect strain applied upon an exterior surface of the integrated frame 610. The integrated frame 610 may be manufactured separately from other elements of a portable electronic device. During assembly of the portable electronic device, the remaining components may be assembled to fit within the integrated frame 610.

FIG. 7 illustrates an example list of various gestures corresponding to one or more of the individual and overall strain metrics produced by the processor 104 as described above. In other words, the various gestures illustrated in FIG. 7 represent inputs recognized by the pressure sensitive device interface described herein. As described above, when external forces such as those illustrated in FIG. 7 are applied to a framing structure of a portable electronic device, the forces imparts strains which may be identified and measured by the pressure sensitive device interface described herein.

Among other gestures, the processor 104 is configured to identify the gestures illustrated in FIG. 7 with reference to the individual and overall strain metrics. As illustrated, gestures that may be identified by the processor 104 include a “squeeze” gesture based upon substantially equal forces being applied at a middle position of two opposing sides of the portable electronic device 100. A “squeeze top” gesture may be identified based upon substantially equal forces applied at an upper position of two opposing sides of the portable electronic device 100. Similarly, a “squeeze bottom” gesture may be identified based upon substantially equal forces applied at a lower position of two opposing sides of the portable electronic device 100.

A “shear right” gesture may be identified by the processor 104 based upon opposite lateral forces applied parallel to respective opposing sides of the portable electronic device 100, and a “shear left” gesture may be identified based upon alternate opposite opposing lateral forces applied parallel to the respective opposing sides of the portable electronic device 100. Another example includes a “splay” gesture. The splay gesture may be identified by the processor 104 based upon downward forces applied at two opposing sides of the framing structure while additionally applying an upward force at a center of a back of the portable electronic device. An exaggerated view of the splay gesture is also illustrated in FIG. 7 to clearly illustrate forces applied in the splay gesture.

The gestures described with reference to FIG. 7 are not exhaustive, and additional gestures may be identified by the processor 104 based upon various forces applied at various locations on an exterior surface of the portable electronic device. Further, as noted above, proportions of each of the gestures may be identified by the processor 104. That is, the processor is configured to identify and distinguish between squeeze gestures across a range of magnitudes. The processor is likewise configured to identify and distinguish between a range of magnitudes of the squeeze top, squeeze bottom, shear right, shear left, and splay gestures. Thus, a user of the portable electronic device 100 is offered a flexible and granular input interface via the pressure sensitive device interface described herein.

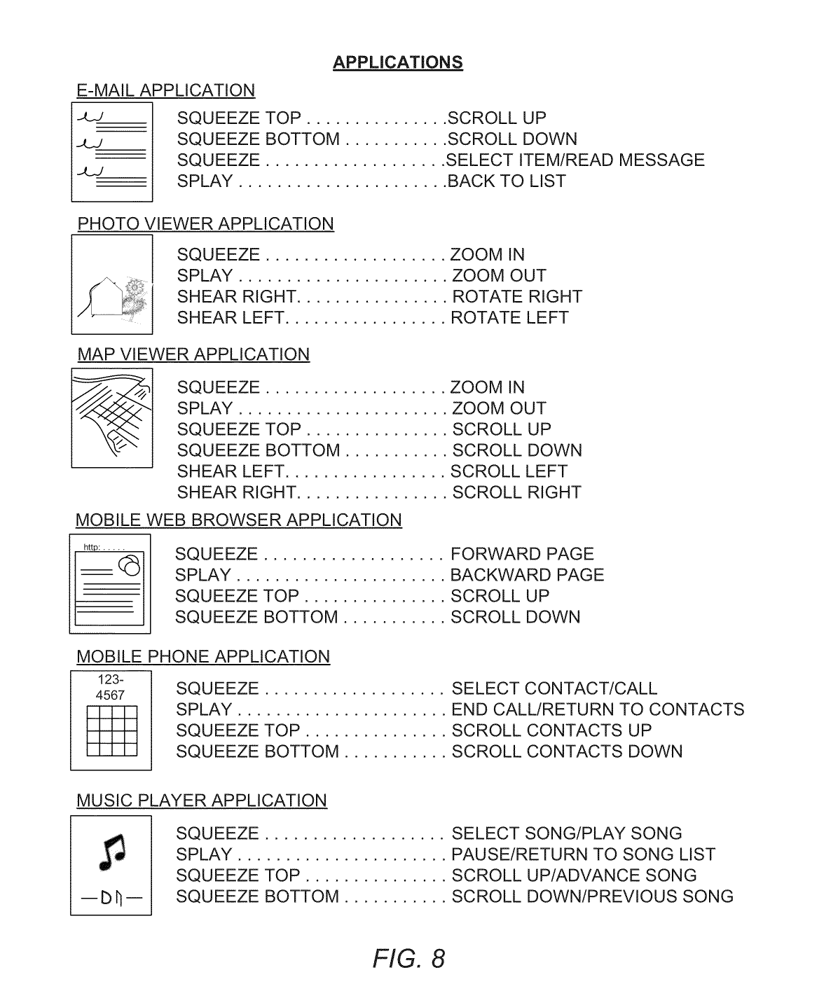

Turning to FIG. 8, the gestures captured by the processor 104, as discussed above with reference to FIG. 7, may be provided as inputs to applications executing on the portable electronic device 100. Each gesture may correspond to a different input or instruction depending upon a currently-displayed or selected application.

With regard to an e-mail application, the squeeze top gesture may control the e-mail application to scroll up within an e-mail on the display 106 or control the display to scroll up within a list of e-mails on the display 106. Similarly, a squeeze bottom gesture may control the application to scroll down within an e-mail or within a list of e-mails on the display 106. The shear right gesture may control the e-mail application to sequence or switch between individual e-mails of a list of e-mails in a first direction. Similarly, the shear left gesture may control the e-mail application to sequence or switch between individual e-mails of the list in a second direction. A splay gesture may control the e-mail application to return to a previously displayed list of e-mails for viewing, delete an e-mail, or close the e-mail application.

With regard to a photo viewer application, a squeeze gesture may control the photo viewer application to zoom in on a photo displayed on the display 106. The splay gesture may control the photo viewer application to zoom out from the picture. A shear right gesture may control the photo viewer application to rotate a picture displayed on the display 106 to the right, and a shear left gesture may control the photo viewer application to rotate the picture to the left.

With regard to a map viewer application, a squeeze gesture may control the map viewer application to zoom in on a map displayed on the display 106, and a splay gesture may control the map viewer application to zoom out from the map. A squeeze bottom gesture may control the map viewer application to scroll down within the map, and a squeeze top gesture may control the map viewer application to scroll up. Similarly, shear right and shear left gestures may control the map viewer application to scroll to the left and right respectively.

With regard to a mobile web browser application, a squeeze gesture may control the mobile web browser application to move forward among browsed websites, and a splay gesture may control the mobile web browser application to scroll backward among browsed websites. A squeeze top gesture may control the mobile web browser application to scroll up within a web page displayed on the display 106, and a squeeze bottom gesture may control the mobile web browser application to scroll down within the displayed web page.

With regard to a mobile phone application, squeeze top and squeeze bottom gestures may control the mobile phone application to scroll up and down through a contacts list, respectively. A squeeze gesture may control the mobile phone address book application to select a contact, and an additional squeeze may control the mobile phone address book to call the selected contact. A splay gesture may control the mobile phone application to end a call, and an additional splay gesture may control the mobile phone application to return to the contacts list.

With regard to a music player application, a list of songs may be scrolled up and down as controlled by respective squeeze top and squeeze bottom gestures. A squeeze gesture may control the music player application to select a song from the list of songs, and an additional squeeze gesture may control the music player application to play the selected song. A splay gesture may control the music play application to pause a song being played and an additional splay gesture may control the music player application to return to the list of songs. While playing a song, squeeze top and bottom gestures may control the music player application to respectively sequence forwards and backwards between songs in a currently-playing play list of songs.

With respect to a gesture, such as the squeeze gesture, a range of magnitudes of the gesture may be measured by the processor 104. With reference to the squeeze gesture and the map viewer application, a first magnitude of the squeeze gesture may control the map viewer application to zoom in by 10% while a second magnitude of the squeeze gesture may control the map viewer application to zoom in by 80%, for example. Similarly, the pressure sensitive device interface described herein is capable of controlling the map viewer application to zoom in by any percentage in proportion to an amount of force applied to the framing structure 210 of the portable electronic device 100. The pressure sensitive device interface described herein incorporates this concept among various ones of the gestures illustrated in FIG. 7 and directions provided to applications illustrated in FIG. 8.

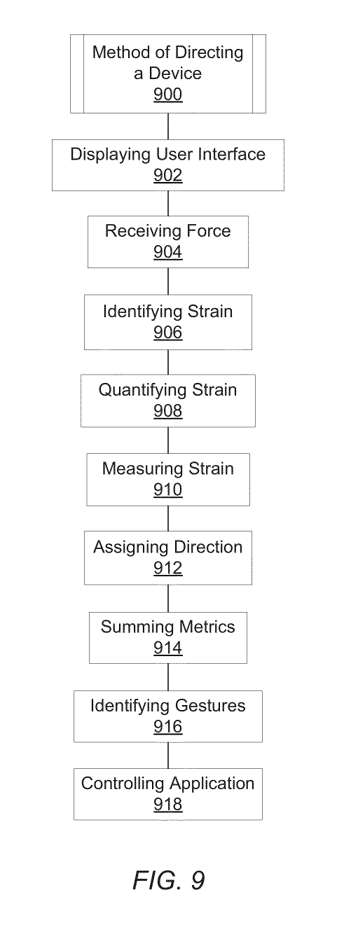

Turning to FIG. 9, a method 900 of controlling a portable device, such as the portable electronic device 100, is described. It is noted that the steps of the method 900 may be performed in an order alternative to that illustrated in FIG. 9, and that steps may be omitted or added within the scope of the method illustrated in FIG. 9.

Step 902 includes displaying a user interface on a display. For example, as described above, the portable electronic device 100 includes the display 230, and the user interface may be displayed on the display 230 at step 902. Step 904 includes receiving a force applied to an external surface of the portable device and exhibiting strain within a framing structure of the portable device. With reference to the portable electronic device 100 illustrated in FIG. 2, step 904 may be performed in conjunction with the framing structure 210, which receives forces applied to exterior surfaces of the portable electronic device 100 and exhibits strain.

Step 906 includes identifying strain using strain gauges integrated with the framing structure of the portable device. For example, strain may be identified by strain gauges such as the strain gauges 350, 352, and 354 described above. Step 908 includes quantifying the strain identified at step 906 according to interface circuitry coupled to the strain gauges. As noted above, a Wheatstone bridge is one example of interface circuitry that quantifies strain identified within the framing structure. Step 910 includes measuring the strain quantified at step 908. The quantified strain may be measured by the processor 104, based upon a change in DC voltage required to rebalance interface circuitry.

Step 912 includes assigning a direction to individual strain metrics according to respective positions, types, and orientations of strain gauges from which the individual strain metrics were measured. In this manner, strain metrics are provided with both magnitude and direction attributes, as described above. Step 914 includes summing the individual strain metrics, each including a magnitude and a direction attribute, according to vector mathematics, to produce an overall metric. In other words, the individual metrics of steps 910 and 912 are summed in view of their magnitude and direction attributes, to generate an overall strain metric. Steps 912 and 914 may be performed by the processor 104, in one embodiment.

Step 916 includes identifying one or more gestures associated with the individual and overall metrics. As one example, the processor 104 identifies gestures according to predetermined associations between particular values of the individual and overall metrics and the gestures described above with reference to FIG. 7. Step 918 includes controlling an application executing on the portable device based on the gesture identified in step 916. With reference to the portable electronic device 100 described above, the processor 104 may control an application to select an item on the display 230, return to a previously displayed list, play a song, and rotate an item on the display 230, for example. The method 900 may comprise additional steps such as storing the individual and overall metrics in a memory, filtering the metrics, and tracking the metrics.

The method 900 may be implemented in hardware, software, or combinations of hardware and software. In one embodiment, the method 900 may be implemented via the elements of the portable electronic device 100 illustrated in FIG. 1. With reference to FIG. 1, the processor 104 may execute one or more of the steps of the method 900 according to instructions stored on the memory 110 that, when executed, direct the processor 104 to execute the one or more steps.

Although specific embodiments have been described above in detail, the description is for purposes of illustration. It should be appreciated that the elements described herein are described above by way of example only and are not intended as being required or essential elements unless explicitly stated otherwise. Various modifications of, and equivalent steps corresponding to, the disclosed aspects of the embodiments described herein, in addition to those described above, may be implemented by a person of ordinary skill in the art, having the benefit of this disclosure, without departing from the spirit and scope of the following claims, the scope of which is to be accorded the broadest interpretation so as to encompass such modifications and equivalent structures.

1. A portable electronic device, comprising:
a display screen that displays a user interface of the portable electronic device;
a framing structure that receives a force applied to an external surface of the portable electronic device and exhibits strain within the framing structure;
a strain gauge that identifies the strain within the framing structure; and
a processor coupled to the display screen and the strain gauge and configured to
measure the strain identified by the strain gauge to produce a measurement of the strain, and
control the user interface according to the measurement of the strain.

2. The portable electronic device of claim 1, wherein the framing structure comprises
a first pair of parallel elements that form opposing elongated outer edges of the portable electronic device, and
a second pair of parallel elements that extend perpendicularly between the first pair of parallel elements at respective ends of the first pair of parallel elements.

3. The portable electronic device of claim 1, further comprising interface circuitry that quantifies the strain within the framing structure.

4. The portable electronic device of claim 1, wherein
the strain gauge comprises a plurality of strain gauges, and
at least one of the plurality of strain gauges is positioned on the framing structure in an orientation that is different than another one of the plurality of strain gauges.

5. The portable electronic device of claim 1, wherein
the strain gauge comprises a plurality of strain gauges, and
each of the plurality of strain gauges is positioned at a respective orientation on the framing structure.

6. The portable electronic device of claim 5, wherein the measurement of the strain includes a magnitude of strain for each of the plurality of strain gauges.

7. The portable electronic device of claim 5, wherein the processor is further configured to
measure a magnitude of strain for each of the plurality of strain gauges, and
for each magnitude of strain, assign a direction to the magnitude of strain to produce an individual strain metric for each of the plurality of strain gauges.

8. The portable electronic device of claim 7, wherein the processor is further configured to sum the individual strain metrics according to vector mathematics to produce an overall strain metric comprising magnitude and direction attributes.

9. The portable electronic device of claim 8, wherein the processor is further configured to identify a gesture with reference to the individual and overall strain metrics.

10. The portable electronic device of claim 9, wherein the gesture comprises a squeeze, a shear, or a splay gesture.

11. The portable electronic device of claim 9, wherein the processor is further configured to control an application executing on the portable electronic device to execute a particular instruction based on the gesture.

12. The portable electronic device of claim 9, wherein the processor is further configured to control an application executing on the portable electronic device to select an item displayed on the display screen according to the squeeze gesture.

13. The portable electronic device of claim 9, wherein the processor is further configured to control an application executing on the portable electronic device to rotate an item displayed on the display screen according to the shear gesture.

14. The portable electronic device of claim 9, wherein the processor is further configured to control an application executing on the portable electronic device to return to a previously displayed list according to the splay gesture.

15. A portable electronic device, comprising:
a framing structure that receives a force applied to the framing structure and exhibits strain within the framing structure;
a strain gauge that identifies the strain within the framing structure; and
a processor configured to
measure the strain identified by the strain gauge to produce a measurement of the strain, and
identify a gesture according to a value of the measurement of the strain.

16. The portable electronic device of claim 15, wherein the measurement of the strain includes a magnitude of the strain.

17. The portable electronic device of claim 16, wherein the processor is further configured to identify a gesture with reference to the magnitude of the strain.

18. The portable electronic device of claim 17, wherein the gesture comprises a squeeze, a shear, or a splay gesture.

19. The portable electronic device of claim 17, wherein the processor is further configured to control an application executing on the portable electronic device to execute a particular instruction based on the gesture.

20. A method of controlling a portable electronic device, comprising:
displaying a user interface of the portable electronic device;
receiving a force applied to an external surface of the portable electronic device and exhibiting strain within a framing structure of the portable electronic device;
identifying, by a strain gauge, the strain within the framing structure; and
measuring the strain identified by the strain gauge.
